(19) United States
(12) Patent Application Publication
(10) Pub. No.: US 2026/0116648 A1
(43) Pub. Date: Apr. 30, 2026

(54) GOODS RECEIVING AND DELIVERING MECHANISM AND CONTAINER

(71) Applicant: MEITUAN TECHNOLOGY CO., LTD., Shenzhen (CN)

(72) Inventors: Haotian WU, Shenzhen (CN); Zhenpeng WANG, Shenzhen (CN); Qin ZHANG, Shenzhen (CN); Hao REN, Shenzhen (CN); Chunyu FENG, Shenzhen (CN)

(73) Assignee: MEITUAN TECHNOLOGY CO., LTD., Shenzhen (CN)

(21) Appl. No.: 19/306,601

(22) Filed: Aug. 21, 2025

(30) Foreign Application Priority Data
Oct. 30, 2024 (CN) 2024 1 1538920.9

(51) Int. Cl. B65D 90/00; B64U 10/13; B64U 101/66

(52) U.S. Cl. CPC B65D 90/0033; B64U 10/13; B64U 2101/66

(57) ABSTRACT

A goods receiving and delivering mechanism includes a receiving and delivering platform, a pushing mechanism and a first cleaning mechanism. The receiving and delivering platform is used for allowing an unmanned aerial vehicle to descend, and the receiving and delivering platform is provided with a connection area for the unmanned aerial vehicle to deliver or receive goods. The pushing mechanism is arranged on the receiving and delivering platform and is used for pushing the unmanned aerial vehicle to move to the connection area. The pushing mechanism is provided with a coverage area capable of covering the receiving and delivering platform through movement and a dead corner area located outside the coverage are.

### CROSS REFERENCE TO RELATED APPLICATION

The present application claims priority to the Chinese Patent Application No. 202411538920.9, filed on Oct. 30, 2024. The entire contents of the above-listed application are hereby incorporated by reference for all purposes.

### BACKGROUND

Owing to popularization of networks and rapid development of distribution industry, an increasing number of people are shopping online to satisfy life requirements. Currently, goods such as takeout and express are transported to a container through an unmanned aerial vehicle, and then taken out by a user at a convenient time according to a situation of the user. Alternatively, goods are stored into a container by a user and then delivered by an unmanned aerial vehicle, thereby improving efficiency of receiving or delivering the goods.

### SUMMARY

The present disclosure relates to the technical field of goods conveyance, and in particular to a goods receiving and delivering mechanism and a container.

An objective of the present disclosure is to provide a goods receiving and delivering mechanism and a container.

In order to achieve the above objective, in a first aspect of the present disclosure, a goods receiving and delivering mechanism is provided. The goods receiving and delivering mechanism includes: a receiving and delivering platform used for allowing an unmanned aerial vehicle to descend, where the receiving and delivering platform is provided with a connection area for the unmanned aerial vehicle to deliver or receive goods; a pushing mechanism arranged on the receiving and delivering platform and used for pushing the unmanned aerial vehicle to move to the connection area, where the pushing mechanism having a coverage area covers the receiving and delivering platform through movement and a dead corner area located outside the coverage area; and a first cleaning mechanism configured to clean at least part of the dead corner area.

In a feasible implementation, the pushing mechanism includes a pushing rod for pushing the unmanned aerial vehicle, and the first cleaning mechanism includes a cleaning rod rotatably connected to the pushing rod.

In a feasible implementation, a first trigger mechanism is arranged on a movement path of the pushing rod connected to the cleaning rod, and the first trigger mechanism is used for rotating the cleaning rod relative to the pushing rod, so as to clean the dead corner area.

In a feasible implementation, the dead corner area is located in the connection area or coincides with the connection area, a second trigger mechanism is further arranged on the movement path of the pushing rod connected to the cleaning rod, the first trigger mechanism is closer to the dead corner area than the second trigger mechanism, and the second trigger mechanism is used for restoring the cleaning rod after rotation of the cleaning rod is triggered by the first trigger mechanism.

In a feasible implementation, an abutting portion is arranged on the cleaning rod, and the first trigger mechanism is used for being capable of abutting against the abutting portion along with movement of the pushing rod towards the dead corner area, so as to rotate the cleaning rod; and the second trigger mechanism is used for being capable of abutting against the abutting portion along with movement of the pushing rod away from the dead corner area, so as to restore the cleaning rod.

In a feasible implementation, one of the cleaning rod and the pushing rod is provided with a guide portion, the other one of the cleaning rod and the pushing rod is provided with a matching portion in sliding fit with the guide portion, the guide portion is provided with a first end and a second end that are used for abutting against the matching portion, the first trigger mechanism abuts against the abutting portion, and the matching portion moves from the first end to the second end along with movement of the pushing rod towards the dead corner area; and the second trigger mechanism abuts against the abutting portion, and the matching portion moves from the second end to the first end along with movement of the pushing rod away from the dead corner area.

In a feasible implementation, the pushing mechanism includes two first pushing rods capable of moving close to or away from each other in a direction X and a second pushing rod capable of moving in a direction Y, and the cleaning rod is connected to at least one of the two first pushing rods and the second pushing rod.

In a feasible implementation, the cleaning rod is arranged on one of the first pushing rods, and a second cleaning mechanism is fixedly connected to the other one of the first pushing rods and the second pushing rod.

In a feasible implementation, a lifting structure is connected to the two first pushing rods, and is used for being capable of lifting the unmanned aerial vehicle away from the receiving and delivering platform when the two first pushing rods move close to each other and the lifting structure makes contact with the unmanned aerial vehicle.

In a feasible implementation, the receiving and delivering platform includes a housing, a pattern recognition structure and a light emitting assembly, and a top surface of the housing is used for allowing the unmanned aerial vehicle to descend and is provided with the connection area; and the pattern recognition structure is located at a top of the housing, a support structure is arranged in the housing, and the support structure is configured with a concave-convex structure to form a support protrusion capable of abutting against the housing and a mounting groove for arranging the light emitting assembly.

In a second aspect of the present disclosure, a container is provided. The container includes: a container body; a grid module arranged on a side wall of the container body; the above goods receiving and delivering mechanism arranged at a top end of the container body; and a conveyance mechanism for conveying goods between the grid module and the goods receiving and delivering mechanism.

In a feasible implementation, the container further includes a top cover assembly, where the top cover assembly is arranged at the top end of the container body, the top cover assembly includes a connection frame, a top cover and a driving mechanism, the connection frame forming a conveyance port in communication with an interior of the container body, and the driving mechanism is configured to drive the top cover to move relative to the conveyance port, so as to shield or expose at least part of the conveyance port; and the driving mechanism includes an electric motor and an adjusting structure for adjusting a position of the electric motor, and the electric motor and/or the adjusting structure are/is located on a side of the connection frame facing the conveyance port.

In a feasible implementation, the conveyance mechanism includes a track located in a conveyance channel of the container body, a vehicle body movably arranged at the track, and a connection mechanism connected to the vehicle body; the track includes a guide area for guiding movement of the vehicle body; and the vehicle body includes a guide assembly and a tensioning assembly configured to engage with the guide area, the guide assembly guiding the vehicle body to move in an extension direction of the track, and the tensioning assembly adjusting a gap between the guide assembly and the track.

### BRIEF DESCRIPTION OF DRAWINGS

The accompanying drawings, used to provide further understanding of the present disclosure, constitute part of the description, and serve to explain the present disclosure along with the following particular implementations, instead of limiting the present disclosure. In the figures:

FIG. 1 is a schematic first-angle diagram of a goods receiving and delivering mechanism according to an embodiment of the present disclosure;

FIG. 2 is a partially enlarged view of a portion A in FIG. 1;

FIG. 3 is a schematic area diagram of a receiving and delivering platform corresponding to a coverage area and a dead corner area of a goods receiving and delivering mechanism according to an embodiment of the present disclosure;

FIG. 4 is a schematic second-angle diagram of a goods receiving and delivering mechanism according to an embodiment of the present disclosure;

FIG. 5 is a schematic diagram when a first cleaning mechanism and a second trigger mechanism of a goods receiving and delivering mechanism abut against each other according to an embodiment of the present disclosure;

FIG. 6 is a schematic structural diagram of a guide portion and a matching portion of a goods receiving and delivering mechanism according to an embodiment of the present disclosure;

FIG. 7 is a schematic structural diagram of an exterior of a housing of a goods receiving and delivering mechanism according to an embodiment of the present disclosure;

FIG. 8 is a schematic structural diagram of an interior of a housing of a goods receiving and delivering mechanism according to an embodiment of the present disclosure;

FIG. 9 is a schematic diagram when a top cover assembly of a container is closed according to an embodiment of the present disclosure;

FIG. 10 is a schematic diagram when a top cover assembly of a container is opened according to an embodiment of the present disclosure;

FIG. 11 is a schematic diagram of connection between a guide track and a vehicle body of a container according to an embodiment of the present disclosure;

FIG. 12 is a schematic partial structural diagram of a vehicle body of a container according to an embodiment of the present disclosure; and

FIG. 13 is a schematic structural diagram of a container body and a grid module of a container according to an embodiment of the present disclosure.

### DESCRIPTIONS OF REFERENCE NUMERALS

1—receiving and delivering platform; 101—connection area; 102—housing; 103—pattern recognition structure; 104—light emitting assembly; 105—support structure; 1051—support protrusion; 1052—mounting groove; 2—pushing mechanism; 201—coverage area; 202—dead corner area; 21—pushing rod; 21a—first pushing rod; 21b—second pushing rod; 3—first cleaning mechanism; 31—cleaning rod; 311—abutting portion; 4—first trigger mechanism; 41—connection portion; 42—abutting matching portion; 5—second trigger mechanism; 6—guide portion; 61—first end; 62—second end; 63—cambered groove; 7—matching portion; 71—guide column; 8—second cleaning mechanism; 9—container body; 10—grid module; 11—top cover assembly; 111—connection frame; 1111—conveyance port; 112—top cover; 113—driving mechanism; 1131—electric motor; 1132—adjusting structure; 12—track; 121—guide area; 1211—guide bottom wall; 1212—guide side wall; 13—vehicle body; 131—guide assembly; 132—tensioning assembly; 1321—screw rod; 1322—nut; and 133—through hole.

### DETAILED DESCRIPTION

The particular implementations of the present disclosure will be described in detail below in combination with the accompanying drawings. It should be understood that the particular implementations described herein are merely used for describing and explaining the present disclosure, and are not intended to limit the present disclosure.

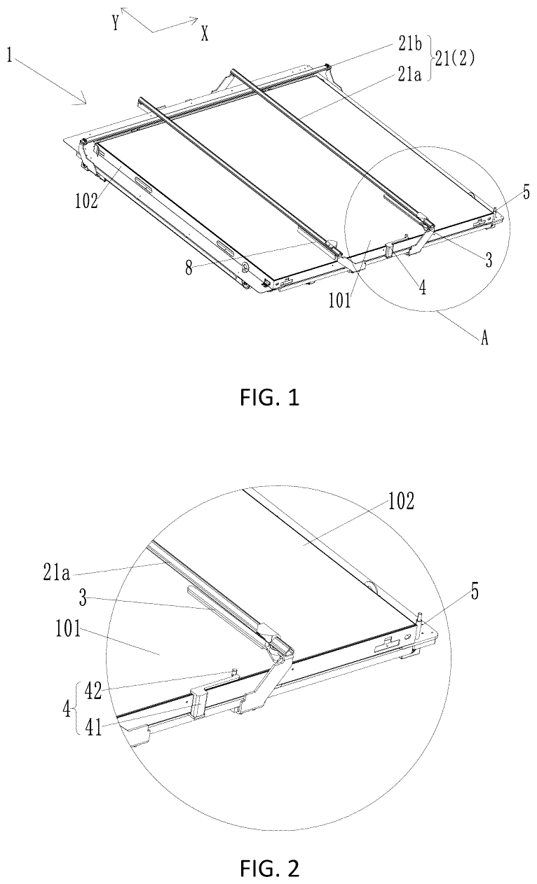

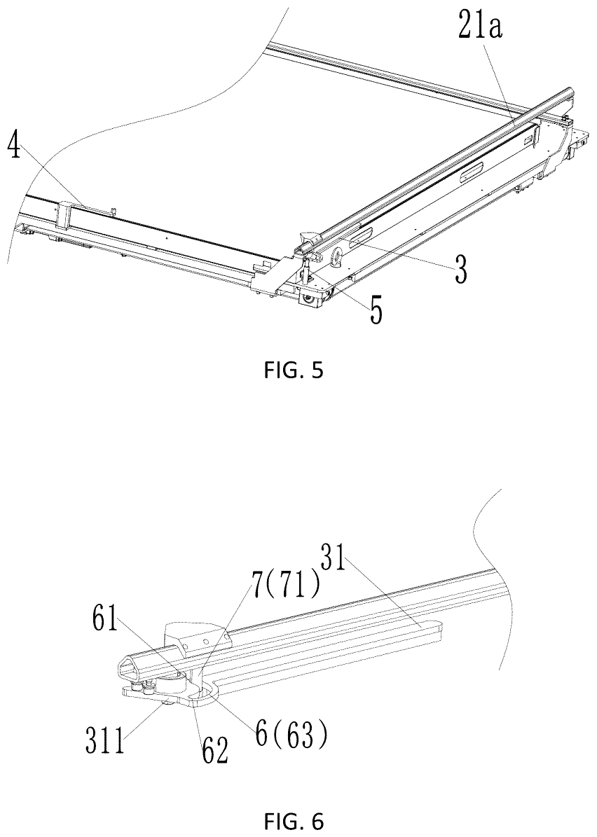

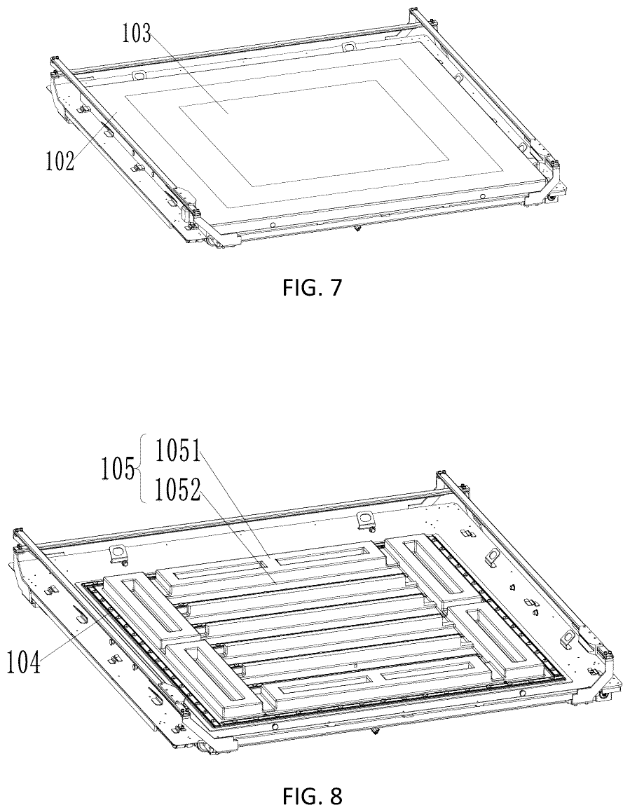

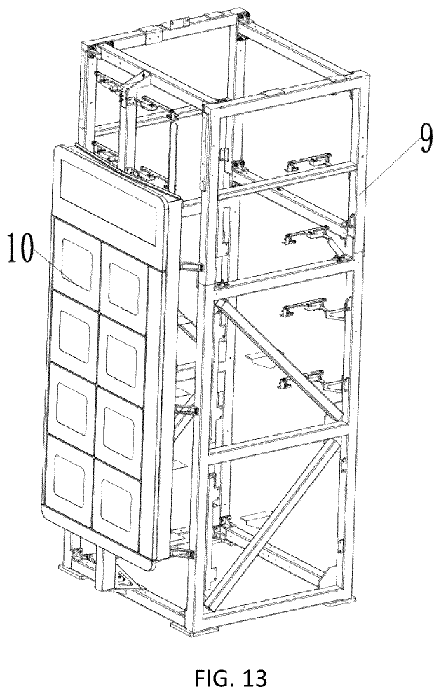

In the present disclosure, unless otherwise stated, directional words used, such as “upper and lower” generally refer to “upper and lower” relative to each other in a gravity direction when a corresponding part is in a use state. Reference can be made to plane directions shown in FIG. 1, FIG. 4, FIG. 5, FIG. 7, FIG. 8 and FIG. 13, and “inner and outer” refer to “inner and outer” relative to an outline of the corresponding component. In addition, terms used in the present disclosure, such as “first” and “second”, are to distinguish one element from another element, and do not have sequence and importance. In addition, when the following description refers to the accompanying drawings, the same reference numerals in different accompanying drawings represent the same or similar elements unless otherwise explained. The above definitions are merely used for explaining and describing the present disclosure, and should not be understood as a limitation on the present disclosure.

A goods receiving and delivering mechanism and a container in examples of the present disclosure will be described below in combination with the accompanying drawings.

The inventor finds through research that after an unmanned aerial vehicle descends to a goods receiving and delivering mechanism, a pushing mechanism on the goods receiving and delivering mechanism adjusts a position of the unmanned aerial vehicle to push the unmanned aerial vehicle to a preset connection area. Thus, it is convenient for a connection mechanism in a container to receive or deliver goods in the connection area.

At present, a cleaning mechanism on a pushing mechanism generally moves along with the pushing mechanism. Thus, a cleaning range of the cleaning mechanism is limited by a movement range of the pushing mechanism. Moreover, due to structure characteristics of the pushing mechanism, the pushing mechanism has part of a dead corner area that may not be covered on a surface of the goods receiving and delivering mechanism. Thus, sundries in the dead corner area may affect movement of the unmanned aerial vehicle in a process in which the pushing mechanism pushes the unmanned aerial vehicle. Thus, the pushing mechanism may not accurately push the unmanned aerial vehicle to a connection area, thereby affecting reception and delivery of the goods.

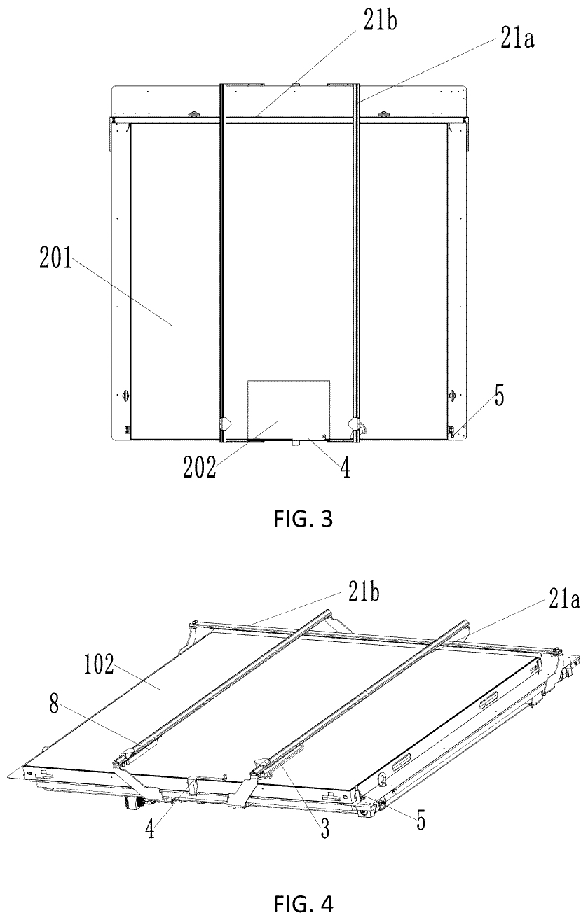

As shown in FIGS. 1-13, in a first aspect of the present disclosure, a goods receiving and delivering mechanism is provided. The goods receiving and delivering mechanism includes a receiving and delivering platform 1, a pushing mechanism 2 and a first cleaning mechanism 3. The receiving and delivering platform 1 is used for allowing an unmanned aerial vehicle to descend, and the receiving and delivering platform 1 is provided with a connection area 101 for the unmanned aerial vehicle to deliver or receive goods. The pushing mechanism 2 is arranged on the receiving and delivering platform 1, and is used for pushing the unmanned aerial vehicle to move to the connection area 101, and the pushing mechanism 2 having a coverage area 201 covers the receiving and delivering platform 1 through movement and a dead corner area 202 located outside the coverage area 201. The first cleaning mechanism 3 is configured to clean at least part of the dead corner area 202. Thus, the first cleaning mechanism 3 can clean at least part of the dead corner area 202 that cannot be cleaned originally under the condition that an original cleaning mechanism of the goods receiving and delivering mechanism can clean the coverage area 201. Thus, the receiving and delivering platform 1 can be cleaned relatively comprehensively under the combined action of the original cleaning mechanism and the first cleaning mechanism, so as to reduce or remove sundries remaining on the receiving and delivering platform 1. Thus, the situation that the unmanned aerial vehicle cannot accurately move to the connection area 101 due to sundries is reduced or even avoided in a process in which the pushing mechanism 2 pushes the unmanned aerial vehicle, thereby improving efficiency of receiving or delivering goods.

The goods receiving and delivering mechanism of the present disclosure can clean the receiving and delivering platform 1 in any period of time, so as to ensure that the unmanned aerial vehicle can be smoothly pushed by the pushing mechanism 2 to the connection area 101. Illustratively, the goods receiving and delivering mechanism can separately clean the receiving and delivering platform 1 before and after the unmanned aerial vehicle delivers the goods, that is, when no unmanned aerial vehicle descends on the receiving and delivering platform 1, so as to reduce or remove the sundries on the receiving and delivering platform 1, and prepare for the pushing mechanism 2 to smoothly push the unmanned aerial vehicle to the connection area 101 subsequently. Alternatively, the goods receiving and delivering mechanism can clean the receiving and delivering platform 1 in a process of pushing the unmanned aerial vehicle. When the unmanned aerial vehicle descends on the receiving and delivering platform 1, the pushing mechanism 2 adjusts the position of the unmanned aerial vehicle, and pushes the unmanned aerial vehicle to the connection area 101, so as to receive or deliver goods. In the process, the first cleaning mechanism 3 can clean the dead corner area 202, and an original cleaning mechanism on the goods receiving and delivering mechanism can clean the coverage area 201. Thus, an effect of cleaning the receiving and delivering platform 1 is improved, and it is convenient for the pushing mechanism 2 to quickly and accurately push the unmanned aerial vehicle to the connection area 101.

In addition, it can be understood that the first cleaning mechanism 3 of the present disclosure may be arranged at different positions of the goods receiving and delivering mechanism according to requirements. For example, the first cleaning mechanism 3 may be arranged on a side edge of the receiving and delivering platform 1, so as to cover the dead corner area 202 through, for example, rotation without interfering with the pushing mechanism 2, thereby cleaning the dead corner area 202. Alternatively, the first cleaning mechanism 3 may be arranged on the pushing mechanism 2 to move along with the pushing mechanism 2, and cover the dead corner area 202 through, for example, rotation or linear movement when the pushing mechanism 2 cannot pass through the dead corner area 202, so as to clean the dead corner area 202.

In an implementation of the present disclosure, as shown in FIGS. 1-6, the pushing mechanism 2 may include a pushing rod 21 for pushing the unmanned aerial vehicle, and the first cleaning mechanism 3 includes a cleaning rod 31 rotatably connected to the pushing rod 21. The cleaning rod 31 may be arranged on one side of the pushing rod 21 close to the receiving and delivering platform 1. Thus, in a process of movement of the pushing rod 21, the cleaning rod 31 may clean the coverage area 201 that may be covered with the pushing rod 21 on the receiving and delivering platform 1 through movement, or may change an area that may be cleaned by the cleaning rod through rotation when the pushing mechanism 2 is about to move or already moves to a limit position, i.e. cleans at least part of the dead corner area that may not be covered with the pushing rod 21 on the receiving and delivering platform 1.

In some implementations, as shown in FIGS. 1-5, in order to ensure that the cleaning rod 31 may rotate at a suitable position to clean the dead corner area 202, a first trigger mechanism 4 is arranged on a movement path of the pushing rod 21 connected to the cleaning rod 31, and the first trigger mechanism 4 is used for rotating the cleaning rod 31 relative to the pushing rod 21, so as to clean the dead corner area 202. After the pushing rod 21 passes through a preset position at which the first trigger mechanism 4 is arranged in a process of movement, the first trigger mechanism 4 rotates the cleaning rod 31, so as to clean at least part of the dead corner area 202 that may not be covered with the pushing rod 21 on the receiving and delivering platform 1, thereby reducing or even removing sundries remaining on the receiving and delivering platform 1, and ensuring that the unmanned aerial vehicle can stably move on the receiving and delivering platform 1 under the action of the pushing rod 21.

In addition, as shown in FIGS. 1-5, the dead corner area 202 of the present disclosure is located in the connection area 101 or coincides with the connection area 101, a second trigger mechanism 5 is further arranged on the movement path of the pushing rod 21 connected to the cleaning rod 31, the first trigger mechanism 4 is closer to the dead corner area 202 than the second trigger mechanism 5, and the second trigger mechanism 5 is used for restoring the cleaning rod 31 after rotation of the cleaning rod is triggered by the first trigger mechanism 4. When the pushing rod 21 is at an initial position, the cleaning rod 31 located on the pushing rod 21 is in an initial state. In the state, the cleaning rod 31 may clean the coverage area 201 in a process of movement along with the pushing rod 21 until the cleaning rod 31 passes through a position of the first trigger mechanism 4. The first trigger mechanism 4 rotates the cleaning rod 31, such that the cleaning rod 31 cleans the dead corner area 202, i.e. cleans the connection area 101 in a process of rotation. Thus, the unmanned aerial vehicle may smoothly move to the connection area 101, thereby improving efficiency of receiving or delivering goods. In a process in which the pushing rod 21 returns to the initial position, the cleaning rod 31 passes through a position at which the second trigger mechanism 5 is located. The second trigger mechanism 5 restores the cleaning rod 31 to the initial state, such that the cleaning rod 31 may subsequently clean the coverage area 201, thereby expanding an application range of the cleaning rod 31.

The first trigger mechanism 4 and the second trigger mechanism 5 may rotate the cleaning rod 31 in various manners. Illustratively, the first trigger mechanism 4 and the second trigger mechanism 5 may make contact with the cleaning rod 31 to apply an external force that may rotate the cleaning rod 31 relative to the pushing rod 21. As shown in FIGS. 1-6, an abutting portion 311 is arranged on the cleaning rod 31, and the first trigger mechanism 4 is used for being capable of abutting against the abutting portion 311 along with movement of the pushing rod 21 towards the dead corner area 202, so as to rotate the cleaning rod 31; and the second trigger mechanism 5 is used for being capable of abutting against the abutting portion 311 along with movement of the pushing rod 21 away from the dead corner area 202, so as to restore the cleaning rod 31. In order to avoid interference between the first trigger mechanism 4 and the second trigger mechanism 5 and the pushing mechanism 2, the first trigger mechanism 4 and the second trigger mechanism 5 may be arranged on a side edge of the receiving and delivering platform 1, and the abutting portion 311 of the cleaning rod 31 is located between the first trigger mechanism and the second trigger mechanism. At least one of the first trigger mechanism 4 and the second trigger mechanism 5 may include a connection portion 41 connected to the receiving and delivering platform 1 and an abutting matching portion 42 connected to the connection portion 41 and capable of abutting against the abutting portion 311 of the cleaning rod 31. The connection portion 41 may be configured as a link extending towards one side of the abutting portion 311 or extending vertically upwards. The abutting matching portion 42 may be arranged at an end portion of the link and is configured as a cylindrical structure. Correspondingly, a cambered side wall capable of matching the cylindrical structure may be formed on the abutting portion 311. Thus, after the abutting portion 311 abuts against the abutting matching portion 42, a rotation process of the cleaning rod 31 may be stabler. In addition, in the implementation, power of the pushing rod 21 may be used for cooperation between the first trigger mechanism 4 and the second trigger mechanism 5, and the cleaning rod 31 without additional power. For example, the cleaning rod 31 may rotate without an additional power source such as an electric motor, and the first trigger mechanism 4 and the second trigger mechanism 5 may transmit a signal without electric energy, such as an electric signal. Thus, a power source may be simplified, and wire harness distribution may be simplified. Moreover, cost may be reduced, and stability of the device may be improved.

Alternatively, in some implementations not shown in the figure, at least one of the first trigger mechanism 4 and the second trigger mechanism 5 may electrically drive the cleaning rod 31 to rotate. For example, at least one of the first trigger mechanism 4 and the second trigger mechanism 5 may include a position sensor arranged on a side edge of the receiving and delivering platform 1. A rotation motor having an output end connected to the cleaning rod 31 is arranged on the pushing rod 21. The position sensor may detect a position of the cleaning rod 31. When detecting passage of the cleaning rod 31, the position sensor may transmit a corresponding electric signal to a controller, and control the rotation motor to drive the cleaning rod 31 to rotate. Thus, the cleaning rod 31 cleans and restores the dead corner area 202.

In an implementation of the present disclosure, as shown in FIGS. 1-6, one of the cleaning rod 31 and the pushing rod 21 is provided with a guide portion 6, the other one of the cleaning rod and the pushing rod is provided with a matching portion 7 in sliding fit with the guide portion 6, the guide portion 6 is provided with a first end 61 and a second end 62 that are used for abutting against the matching portion 42, and the first trigger mechanism 4 abuts against the abutting portion 311, such that the matching portion 7 moves from the first end 61 to the second end 62 along with movement of the pushing rod 21 towards the dead corner area 202; and the second trigger mechanism 5 abuts against the abutting portion 311, such that the matching portion 7 moves from the second end 62 to the first end 61 along with movement of the pushing rod 21 away from the dead corner area 202. The matching portion 7 may abut against the first end 61 of the guide portion 6 when the pushing rod 21 is at the initial position. In this case, the pushing rod 21 moves, and the cleaning rod 31 is continuously in the initial state and may clean the coverage area 201 until the first trigger mechanism 4 abuts against one side of the abutting portion 311 of the cleaning rod 31, such that the cleaning rod 31 has a tendency to rotate. The pushing rod 21 continues moving in an initial movement direction, the cleaning rod 31 starts to rotate, and the second end 62 of the guide portion 6 moves towards the matching portion 7. After the matching portion 7 abuts against the second end 62, the cleaning rod 31 stops rotating. In a process of rotation of the cleaning rod 31, an area that may be cleaned by the cleaning rod 31 is changed. Thus, the cleaning rod 31 may clean the dead corner area 202. When the pushing rod 21 reversely moves back to the initial position, the matching portion 7 may still abut against the second end 62 of the guide portion 6 or be located between the first end 61 and the second end 62 until the second trigger mechanism 5 abuts against the other side of the abutting portion 311. In this case, the cleaning rod 31 has a tendency to rotate reversely. The pushing rod 21 continues moving towards the initial position, the cleaning rod 31 starts to rotate reversely, and the first end 61 of the guide portion 6 moves towards the matching portion 7 until the first end 61 abuts against the matching portion 7. Thus, the cleaning rod 31 is restored to the initial state, and it is convenient for the cleaning rod to subsequently clean the coverage area 201 of the receiving and delivering platform 1.

The guide portion 6 may be configured as a cambered groove 63 provided on the pushing rod 21/the cleaning rod 31. A length and a radian of the cambered groove 63 may be adaptively adjusted according to an angle by which the cleaning rod 31 needs to rotate. Correspondingly, the matching portion 7 may be configured as a guide column 71 arranged on the cleaning rod 31/the pushing rod 21. One end of the guide column 71 is connected to the cleaning rod 31/the pushing rod 21, and the other end of the guide column 71 is in sliding connection with the cambered groove 63, and when the guide column 71 abuts against the first end 61 or the second end 62 of the cambered groove 63, movement of the cleaning rod 31 is limited.

In addition, the cleaning rod 31 may be constructed in any suitable manner. For example, the cleaning rod 31 may include a rod body and a brush or a sponge detachably connected to the rod body, which is not specifically limited in the present disclosure. The above abutting portion 311 and the above guide portion 6 may be arranged on the rod body.

In another implementation not shown in the figure, the cleaning rod 31 may be restored through an elastic restoration member such as a spring or a torsional spring. For example, when the first trigger mechanism 4 abuts against the cleaning rod 31 to rotate the cleaning rod 31, a force may be accumulated to the elastic restoration member. When the pushing rod 21 moves away from the dead corner area 202, the cleaning rod 31 is gradually restored through the elastic restoration member.

In some implementations, as shown in FIGS. 1-6, the pushing mechanism 2 may include two first pushing rods 21a capable of moving close to or away from each other in a direction X and a second pushing rod 21b capable of moving in a direction Y, and the cleaning rod 31 is connected to at least one of the two first pushing rods 21a and the second pushing rod 21b. After the unmanned aerial vehicle descends to the receiving and delivering platform 1, the first pushing rod 21a may adjust a position of the unmanned aerial vehicle in the direction X. Generally, for ease of connection, the connection area 101 may be located at a central location of a side edge of the receiving and delivering platform 1. Thus, the two first pushing rods 21a may be simultaneously close to each other from two sides of the receiving and delivering platform 1 at a same speed, such that the unmanned aerial vehicle may be arranged opposite the connection area 101 in the direction Y under an action of the two first pushing rods 21a. Then, the second pushing rod 21b moves towards one side of the connection area 101 in the direction Y to push the unmanned aerial vehicle to the connection area 101 for goods receiving and delivering operation. Clearly, when pushing the unmanned aerial vehicle, the pushing mechanism 2 may adjust a position of the unmanned aerial vehicle in the direction Y through the second pushing rod 21b, and then adjust a position of the unmanned aerial vehicle in the direction X through the two first pushing rods 21a.

In addition, as shown in FIGS. 1-5, the cleaning rod 31 may be arranged on one of the first pushing rods 21a, and a second cleaning mechanism 8 is fixedly connected to the other one of the first pushing rods 21a and the second pushing rod 21b. The second cleaning mechanism 8 may include a rod body used for being connected to the first pushing rod 21a and/or the second pushing rod 21b and a cleaning brush used for cleaning sundries on the receiving and delivering platform 1. In a process in which the pushing mechanism 2 pushes the unmanned aerial vehicle to the connection area 101, the first cleaning mechanism 3 and the second cleaning mechanism 8 may clean the coverage area 201. When the first pushing rod 21a having the first cleaning mechanism 3 passes through the first trigger mechanism 4, the cleaning rod 31 of the first cleaning mechanism 3 rotates to clean the dead corner area 202.

Illustratively, after the unmanned aerial vehicle descends to the receiving and delivering platform 1, the two first pushing rods 21a may be close to each other in the direction X to adjust the position of the unmanned aerial vehicle in the direction X. In the process, the first cleaning mechanism 3 and the second cleaning mechanism 8 clean part of the coverage area 201, and the first cleaning mechanism 3 may further rotate to clean the dead corner area 202 after passing through the first trigger mechanism 4. Subsequently, the second pushing rod 21b moves in the direction Y to push the unmanned aerial vehicle to the connection area 101 and simultaneously clean the remaining coverage area 201. Thus, the goods receiving and delivering mechanism cleans the receiving and delivering platform 1 while receiving or delivering goods.

In addition, a lifting structure (not shown in the figure) may be connected to the two first pushing rods 21a, and is used for being capable of lifting the unmanned aerial vehicle away from the receiving and delivering platform 1 when the two first pushing rods 21a move close to each other and the lifting structure makes contact with the unmanned aerial vehicle. Thus, when the second pushing rod 21b pushes the unmanned aerial vehicle to the connection area 101 in the direction Y, the unmanned aerial vehicle does not make contact with the receiving and delivering platform 1, thereby ensuring that the unmanned aerial vehicle may move to the connection area 101 more smoothly. In addition, since a distance exists between the unmanned aerial vehicle and the receiving and delivering platform 1 to some extent, the first cleaning mechanism 3 may clean the dead corner area 202 even if the unmanned aerial vehicle is located in the connection area 101. That is, the first cleaning mechanism 3 may clean the connection area 101 at different periods of time without interfering with the unmanned aerial vehicle.

The lifting structure may include, for example, a lifting block. The lifting block is provided with guiding inclined surfaces. The two guiding inclined surfaces obliquely extend away from each other from bottom to top. Matching inclined surfaces matching the guiding inclined surfaces may be arranged on support legs of the unmanned aerial vehicle. Thus, when two first pushing rods 21a move close to each other, the unmanned aerial vehicle may be lifted through the two guiding inclined surfaces.

In addition, no lifting structure may be arranged on the first pushing rod 21a. In the implementation, the pushing rod 21 or the first pushing rod 21a has a pushing position for positioning the unmanned aerial vehicle on the receiving and delivering platform 1. At the pushing position, the first trigger mechanism 4 does not trigger rotation of the cleaning rod 31, i.e. does not interfere with normal goods receiving and delivering of the unmanned aerial vehicle. In the implementation, after the unmanned aerial vehicle flies away or before the unmanned aerial vehicle descends, the pushing rod 21 continues moving towards the dead corner area 202 after passing through the pushing location, so as to trigger rotation of the cleaning rod 31 through the first trigger mechanism 4, so as to clean the dead corner area 202. Alternatively, the cleaning rod 31 may be arranged on the first pushing rods 21a. When the two first pushing rods 21a may move towards each other, so as to reach the pushing position, the cleaning rod 31 may already complete a process of rotation and cleaning through the first trigger mechanism 4. Subsequently, the second pushing rod 21b pushes the unmanned aerial vehicle to move to the connection area 101.

The pushing rod 21 may move in any suitable existing manner. For example, the pushing mechanism 2 may include a driving motor and a synchronous belt conveyance mechanism. The driving motor may drive the pushing rod 21 to move through the synchronous belt conveyance mechanism, which is not specifically limited in the present disclosure.

In an implementation of the present disclosure, as shown in FIGS. 7 and 8, the receiving and delivering platform 1 may include a housing 102, a pattern recognition structure 103 and a light emitting assembly 104, and a top surface of the housing 102 is used for allowing the unmanned aerial vehicle to descend and is provided with the connection area 101; and the pattern recognition structure 103 is located at the top of the housing 102, a support structure 105 is arranged in the housing 102, and the support structure 105 is configured with a concave-convex structure to form a support protrusion 1051 capable of abutting against the housing 102 and a mounting groove 1052 for arranging the light emitting assembly 104. The pattern recognition structure 103 may be used for positioning and recognizing the unmanned aerial vehicle. The pattern recognition structure may be constructed as a pattern recognition code to be pasted at the top of the housing 102, such that it is convenient to replace the pattern recognition structure 103 while the unmanned aerial vehicle may accurately descend to the housing 102 of the receiving and delivering platform 1.

In addition, the housing 102 may be made of a polycarbonate (PC) material having excellent transparency and impact resistance, so as to reduce weight of the housing 102. In addition, when an ambient environment is dark and the pattern recognition structure 103 is difficult to recognize, light emitted by the light emitting assembly 104 located in the housing 102, such as a light emitting diode (LED) light bar may pass through the housing 102, so as to improve brightness of the pattern recognition structure 103 and position and recognize the unmanned aerial vehicle conveniently. Clearly, in order to further improve brightness of the pattern recognition structure 103, the light emitting assembly 104 in the housing 102 may be arranged corresponding to the pattern recognition structure 103 outside the housing 102 on an inner side and an outer side of the housing 102.

In addition, the support structure 105 configured with a concave-convex structure may be made of a PC material to further reduce the weight of the receiving and delivering platform 1. The support protrusion 1051 may be arranged to increase a support area between the support protrusion and the housing 102, improve strength of the housing 102, and reduce or even avoid the situation that the housing 102 is deformed due to an external force. The mounting groove 1052 may be arranged to mount the light emitting assembly 104, and the light emitting assembly 104 may be mounted without a separate tool, thereby simplifying a structure of the receiving and delivering platform 1.

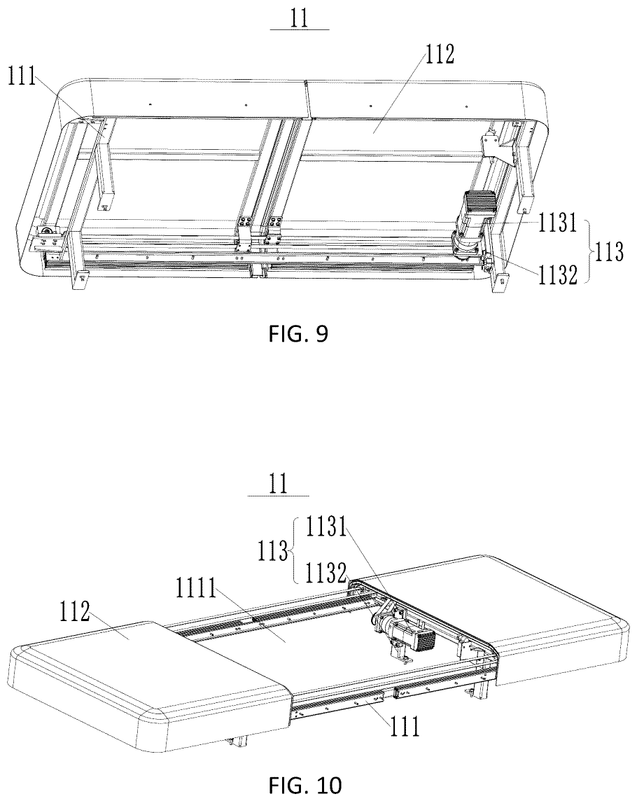

In a second aspect of the present disclosure, as shown in FIGS. 9-13, a container is provided. The container includes a container body 9; a grid module 10, the above goods receiving and delivering mechanism, and a conveyance mechanism. The grid module 10 is arranged on a side wall of the container body 9; the goods receiving and delivering mechanism is arranged at a top end of the container body 9; and the conveyance mechanism is used for conveying goods between the grid module 10 and the goods receiving and delivering mechanism. After an unmanned aerial vehicle descends to a receiving and delivering platform 1, a pushing mechanism 2 pushes the unmanned aerial vehicle to a connection area 101. Then, the conveyance mechanism may transfer goods conveyed by the unmanned aerial vehicle to the grid module 10, so as to receive the goods, or conveys goods in the grid module 10 to the unmanned aerial vehicle on the receiving and delivering platform 1 to deliver the goods. Thus, the goods are received or delivered.

In an implementation of the present disclosure, as shown in FIGS. 9 and 10, the container may further include a top cover assembly 11. The top cover assembly 11 is arranged at the top end of the container body 9, the top cover assembly 11 includes a connection frame 111, a top cover 112 and a driving mechanism 113, the connection frame 111 forming a conveyance port 1111 in communication with an interior of the container body 9, and the driving mechanism 113 is configured to drive the top cover 112 to move relative to the conveyance port 1111, so as to shield or expose at least part of the conveyance port 1111; and the driving mechanism 113 includes an electric motor 1131 and an adjusting structure 1132 for adjusting a position of the electric motor 1131, and the electric motor 1131 and/or the adjusting structure 1132 are/is located on a side of the connection frame 111 facing the conveyance port 1111. When the conveyance mechanism receives and delivers goods between the goods receiving and delivering mechanism and the grid module 10, the driving mechanism 113 may drive the top cover 112 to move, so as to expose the conveyance port 1111. The electric motor 1131 and/or the adjusting structure 1132 of the driving mechanism 113 are/is arranged on one side of the connection frame 111 towards the conveyance port 1111, such that when the top cover 112 is opened, it is convenient for a worker to disassemble, assemble and repair the top cover.

The electric motor 1131 may drive the top cover 112 to move in any suitable existing manner. For example, the electric motor 1131 may drive the top cover 112 to move through a synchronous belt conveyance mechanism. In the implementation, the adjusting structure 1132 may be configured as a tensioning structure, so as to adjust a degree of tightness of a belt by adjusting a position of the electric motor 1131.

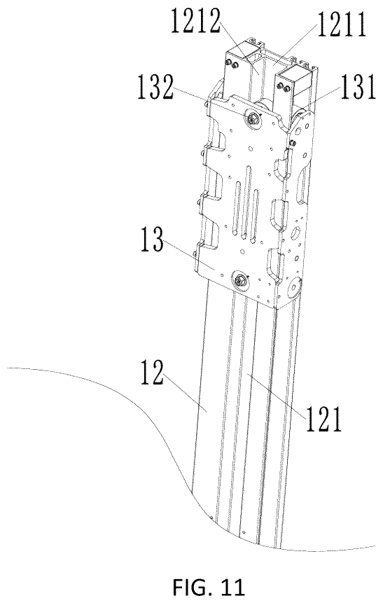

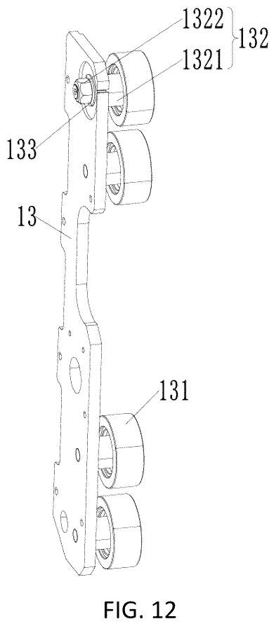

In some implementations, as shown in FIGS. 11 and 12, a conveyance mechanism includes a track 12 located in a conveyance channel of the container body 9, a vehicle body 13 movably arranged at the track 12, and a connection mechanism (not shown in the figure) connected to the vehicle body 13; the track 12 includes a guide area 121 for guiding movement of the vehicle body 13; and the vehicle body 13 includes a guide assembly 131 and a tensioning assembly 132 configured to engage with the guide area 121, the guide assembly 131 guiding the vehicle body 13 to move in an extension direction of the track 12, and the tensioning assembly 132 adjusting a gap between the guide assembly 131 and the track 12. When the container receives and delivers goods, the vehicle body 13 moves up and down in the track 12 to take and place the goods between the goods receiving and delivering mechanism and the grid module 10 through the connection mechanism. The tensioning assembly 132 may reduce the gap between the guide assembly 131 on the vehicle body 13 and the track 12, such that the vehicle body 13 is more tightly connected to the track 12. Thus, stability when the vehicle body 13 moves on the track 12 is improved. The guide area 121 may be configured as a guide groove recessed into the track 12. The guide groove includes a guide bottom wall 1211 and guide side walls 1212 on two opposite sides of the guide bottom wall 1211. An extension direction of the guide side walls 1212 is parallel to a movement direction of the vehicle body 13. The tensioning assembly 132 may include a screw rod 1321 and a nut 1322 used for connecting the screw rod 1321 to the vehicle body 13. The guide assembly 131 may be configured as a guide wheel. The guide wheel rolls in the guide groove to enable the vehicle body to move on the track 12 in a reciprocating manner. At least one guide wheel may be eccentrically connected to the screw rod 1321. A through hole 133 may be provided on the vehicle body 13 for the screw rod 1321 to pass through, and the guide wheel is fixed to the vehicle body 13 by the nut 1322. Since the screw rod 1321 and the guide wheels are eccentrically arranged, a position of an axis of the guide wheel may be adjusted when the screw rod 1321 rotates. For example, the guide wheel approaches one guide side wall 1212 to enhance a friction force between the guide wheel and the guide side wall 1212, so as to achieve the effect of pretensioning. Thus, a gap between the guide wheel and the correspondingly contacted guide side wall 1212 is reduced, such that the vehicle body 13 is more tightly connected to the track 12, and stability when the vehicle body 13 moves on the track 12 is ensured.

In addition, an existing mechanism such as a manipulator may be used as the connection mechanism, which is not described in the present disclosure for brevity.

In conclusion, the present disclosure illustratively shows the goods receiving and delivering mechanism and a working process of receiving or delivering goods by the container.

Whether to turn on the light emitting assembly 104 in the housing 102 may be determined according to current ambient brightness, so as to improve brightness of the pattern recognition structure 103 located at the top of the housing 102. Thus, the unmanned aerial vehicle may position and recognize the receiving and delivering platform 1 and descend on the receiving and delivering platform 1. After the unmanned aerial vehicle descends, the two first pushing rods 21a located on the two sides of the receiving and delivering platform 1 are close to each other, so as to adjust a position of the unmanned aerial vehicle in the direction X until the unmanned aerial vehicle is arranged opposite the connection area 101. The first cleaning mechanism 3 is located on the first pushing rod 21a on a right side, the second cleaning mechanism 8 is located on the first pushing rod 21a on a left side, the first trigger mechanism 4 is located on one side of the receiving and delivering platform 1 close to the connection area 101, and the second trigger mechanism 5 is located on a right side of the receiving and delivering platform 1. When the two first pushing rods 21a are close to each other from the initial location, the second cleaning mechanism 8 located on the first pushing rod 21a on the left side may clean part of an area on a left side of the connection area 101, and in this case, the first cleaning mechanism 3 located on the first pushing rod 21a on the right side may clean part of an area on a right side of the connection area 101. When the first trigger mechanism 4 abuts against the cleaning rod 31 of the first cleaning mechanism 3, the cleaning rod 31 rotates anticlockwise to clean the dead corner area 202 (connection area 101) in a process of rotation. That is, the first cleaning mechanism 3 and the second cleaning mechanism 8 may clean the dead corner area 202 and part of the coverage area 201 on the receiving and delivering platform 1 when adjusting the position of the unmanned aerial vehicle in the direction X. Then, the second pushing rod 21b moves in the direction Y to push the unmanned aerial vehicle to the connection area 101. In the process, the remaining coverage area 201 on the receiving and delivering platform 1 is cleaned through the second cleaning mechanism 8. Based on this, sundries remaining on the receiving and delivering platform 1 is reduced or removed. Thus, the situation that the unmanned aerial vehicle cannot accurately move to the connection area 101 due to sundries is reduced or even avoided in a process in which the pushing mechanism 2 pushes the unmanned aerial vehicle, thereby improving efficiency of receiving or delivering goods.

After the unmanned aerial vehicle moves to the connection area 101, the vehicle body 13 of the conveyance mechanism may move between the goods receiving and delivering mechanism and the grid module 10 through the track 12. Thus, goods can be received and delivered between the goods receiving and delivering mechanism and the grid module 10 through the connection mechanism.

The preferred implementations of the present disclosure are described in detail above in combination with the accompanying drawings. However, the present disclosure is not limited to specific details of the above implementations. Within the scope of the technical concept of the present disclosure, various simple modifications can be made to the technical solutions of the present disclosure, and these simple modifications all fall within the scope of protection of the present disclosure.

Moreover, it should be noted that various specific technical features described in the above particular implementations can be combined in any suitable manner without contradiction, and in order to avoid unnecessary repetition, various possible combinations are not separately explained in the present disclosure.

In addition, different implementations of the present disclosure can be freely combined as long as the combinations do not violate the idea of the present disclosure, and the combinations should also be regarded as the content disclosed in the present disclosure.

1. A container, comprising:
a container body;
a grid module arranged on a side wall of the container body;
a goods receiving and delivering mechanism arranged at a top end of the container body;
a conveyance mechanism for conveying goods between the grid module and the goods receiving and delivering mechanism; and
a top cover assembly arranged at the top end of the container body, wherein the top cover assembly comprises a connection frame, a top cover and a driving mechanism, wherein the connection frame forming a conveyance port in communication with an interior of the container body, and wherein the driving mechanism is configured to drive the top cover to move relative to the conveyance port, so as to shield or expose at least part of the conveyance port.

2. The container according to claim 1, wherein the top cover is driven by the driving mechanism to move to expose the conveyance port when the conveyance mechanism receives or delivers goods between the goods receiving and delivering mechanism and the grid module.

3. The container according to claim 1, wherein the driving mechanism comprises an electric motor and an adjusting structure for adjusting a position of the electric motor, and at least one of the electric motor and the adjusting structure is located on a side of the connection frame facing the conveyance port.

4. The container according to claim 1, wherein the conveyance mechanism comprises a track located in a conveyance channel of the container body, a vehicle body movably arranged on the track, and a connection mechanism connected to the vehicle body; wherein
the track comprises a guide area for guiding movement of the vehicle body; and wherein
the vehicle body comprises a guide assembly and a tensioning assembly configured to engage with the guide area, the guide assembly guiding the vehicle body to move in an extension direction of the track, and the tensioning assembly adjusting a gap between the guide assembly and the track.

5. The container according to claim 4, wherein the guide area is configured as a guide groove recessed into the track, wherein the guide groove includes a guide bottom wall and guide side walls on opposite sides of the guide bottom wall, and wherein an extension direction of the guide side walls is parallel to a movement direction of the vehicle body.

6. The container according to claim 4, wherein the tensioning assembly includes a screw rod and a nut for connecting the screw rod to the vehicle body, wherein the guide assembly is configured as a guide wheel, and wherein the guide wheel rolls in the guide groove to enable the vehicle body to move along the track in a reciprocating manner.

7. The container according to claim 6, wherein at least one guide wheel is eccentrically connected to the screw rod, wherein a through hole is provided on the vehicle body for the screw rod to pass through, and the guide wheel is fixed to the vehicle body by the nut.

8. The container according to claim 4, wherein the connection mechanism is a manipulator.

9. The container according to claim 1, wherein the goods receiving and delivering mechanism comprising a receiving and delivering platform for allowing an unmanned aerial vehicle to descend, wherein the receiving and delivering platform is provided with a connection area for the unmanned aerial vehicle to deliver or receive goods.

10. The container according to claim 9, wherein the receiving and delivering platform comprises a housing, a pattern recognition structure and a light emitting assembly, and wherein a top surface of the housing for allowing the unmanned aerial vehicle to descend is provided with the connection area.

11. The container according to claim 10, wherein the pattern recognition structure is located at a top of the housing, a support structure is arranged in the housing, and the support structure is configured with a concave-convex structure to form a support protrusion capable of abutting against the housing and a mounting groove for arranging the light emitting assembly.

12. The container according to claim 9, wherein the goods receiving and delivering mechanism further comprising:
a pushing mechanism arranged on the receiving and delivering platform for pushing the unmanned aerial vehicle to move to the connection area, wherein the pushing mechanism having a coverage area that covers the receiving and delivering platform through movement and a dead corner area located outside the coverage area; and
a first cleaning mechanism configured to clean at least part of the dead corner area.

13. The container according to claim 12, wherein the pushing mechanism comprises a pushing rod for pushing the unmanned aerial vehicle, and the first cleaning mechanism comprises a cleaning rod rotatably connected to the pushing rod.

14. The container according to claim 13, wherein a first trigger mechanism is arranged on a movement path of the pushing rod, and the first trigger mechanism being configured to rotate the cleaning rod relative to the pushing rod to clean the dead corner area.

15. The container according to claim 14, wherein the dead corner area is located in the connection area or coincides with the connection area, and a second trigger mechanism is further arranged on the movement path of the pushing rod, the first trigger mechanism being closer to the dead corner area than the second trigger mechanism, and the second trigger mechanism being configured to restore the cleaning rod after the cleaning rod is rotated by the first trigger mechanism.

16. The container according to claim 15, wherein an abutting portion is arranged on the cleaning rod, and the first trigger mechanism is configured to abut against the abutting portion during movement of the pushing rod towards the dead corner area, so as to rotate the cleaning rod; and
the second trigger mechanism is configured to abut against the abutting portion during movement of the pushing rod away from the dead corner area, so as to restore the cleaning rod.

17. The container according to claim 16, wherein one of the cleaning rod and the pushing rod is provided with a guide portion, the other of the cleaning rod and the pushing rod is provided with a matching portion in sliding fit with the guide portion, the guide portion has a first end and a second end for abutting against the matching portion;
when the first trigger mechanism abuts against the abutting portion, the matching portion moves from the first end to the second end during movement of the pushing rod towards the dead corner area; and
when the second trigger mechanism abuts against the abutting portion, the matching portion moves from the second end to the first end during movement of the pushing rod away from the dead corner area.

18. The container according to claim 13, wherein the pushing mechanism comprises two first pushing rods movable close to or away from each other in a direction X and a second pushing rod movable in a direction Y, and the cleaning rod is connected to at least one of the two first pushing rods and the second pushing rod.

19. The container according to claim 18, wherein the cleaning rod is arranged on one of the first pushing rods, and a second cleaning mechanism is fixedly connected to the other of the first pushing rods and to the second pushing rod.

20. The container according to claim 18, wherein a lifting structure is connected to the two first pushing rods, and is configured to lift the unmanned aerial vehicle away from the receiving and delivering platform when the two first pushing rods move close to each other and the lifting structure contacts the unmanned aerial vehicle.
